(19) United States
(12) Patent Application Publication
(10) Pub. No.: US 2025/0390072 A1
(43) Pub. Date: Dec. 25, 2025

(54) PRECISE CONCENTRATION GENERATING DEVICE FOR DUST PARTICLES AND DUST GENERATION SIMULATION METHOD THEREOF

(71) Applicant: SHANDONG UNIVERSITY OF SCIENCE AND TECHNOLOGY, Qingdao (CN)

(72) Inventors: Haiming YU, Qingdao (CN); Xiangchen ZHANG, Qingdao (CN); Xinyue ZHANG, Qingdao (CN); Junyi CHEN, Qingdao (CN); Weimin CHENG, Qingdao (CN)

(21) Appl. No.: 19/073,784

(22) Filed: Mar. 7, 2025

(30) Foreign Application Priority Data
Jun. 24, 2024 (CN) 202410820946.6

(51) Int. Cl. G05B 15/02; G01V 99/00

(52) U.S. Cl. CPC G05B 15/02; G01V 99/00

(57) ABSTRACT

Provided are a precise concentration generating device and a dust generation simulation method for dust particles, wherein the device includes a smoke cake particle generator and a water tank. The top of the smoke cake particle generator is equipped with a feeding port, and the bottom is equipped with a discharging port. The discharging port is connected to a material conveying pipeline, and the initial end of the material conveying pipeline is connected to a material conveying fan. The end of the material conveying pipeline is connected to the cyclone chamber of the cyclone cylinder, and a high-temperature heating tube is set at the bottom of the cyclone chamber. The top of the cyclone cylinder is equipped with a dust outlet, and the bottom of the cyclone cylinder is equipped with a slag discharge port.

### CROSS-REFERENCE TO RELATED APPLICATIONS

This application claims priority to Chinese Application No. CN202410820946.6, filed on Jun. 24, 2024, entitled “PRECISE CONCENTRATION GENERATING DEVICE FOR DUST PARTICLES AND DUST GENERATION SIMULATION METHOD THEREOF”.

These contents are hereby incorporated by reference.

### TECHNICAL FIELD

The present disclosure belongs to the technical field of mine dust pollution, relates to an experimental equipment, in particular to a precise concentration generating device for dust particles and a dust generation simulation method thereof.

### BACKGROUND

With the increase of mining depth, dust pollution also increases. High concentration dust seriously affects the safe mining of coal mines. When the dust concentration reaches a certain level, serious explosion accidents are prone to occur when encountering open flames. At the same time, workers who work in high concentration dust environments for a long time are prone to get pneumoconiosis, which has attracted high attention from society regarding the safety of mineral operations.

In order to solve the problem of dust pollution, colleges and universities, scientific research institutes and other institutions have built a large number of dust simulation experimental platforms to study the ventilation control and mechanism of reducing dust by spray, so as to develop efficient dust removal technology and equipment, wherein simulating the dust generation process of mine dust is extremely important, and the main dust generation methods include: (1) dust blowing: by using nozzles or spray guns to spray dust materials into the air to form a certain concentration of dust, simulating the dust generated during coal mining process; (2) vibration device: use a vibration device to shake off dust into the air, simulating the dust generated during excavation or vibration processes; (3) ground dust: by allowing dust to fall freely from a high place, dust clouds are generated to simulate the dust generation process during coal transportation in mines. The main source of dust generation in coal mine environment is the dust generated during the process of cutting coal and rock, and its main dust generation should be dust blowing. However, due to the extremely small size of dust particles, with an average particle size generally below 10 μm, it is difficult to sample them on site. The efficiency of dust grinding through crushers, vibration mills, and ball mills is very low, making it difficult to produce a large number of fine dust particles. In the development process of many experimental platforms, smoke generated by the combustion of smoke cakes is often used to simulate dust. The average particle size of smoke particles is generally less than 10 μm, which can effectively simulate the changes of dust with airflow. The demand for using smoke particles to simulate dust particles is gradually increasing. However, the combustion process of the smoke cake is uncontrollable, especially the concentration of particulate matter in the smoke is difficult to accurately adjust, making it impossible to smoke or extinguish at any time, resulting in weak operability in most experimental processes.

The existing dust particle generation devices include two types:

(1) A generation device used a liquid smoke agent as raw materials. After being heated and evaporated, the liquid smoke agent solidifies into dust particles when encountering cooler air. This type of dust particle generation device consumes a large amount of e-liquid, has a high cost, and cannot control humidity. The generated dust particles have a large particle size and generally settle to the bottom, especially for fine dust particles with a particle size less than 10 μm that cannot be simulated.

(2) A device for generating grinding powder as raw material. Generally, dust is first generated through a crushing machine, a vibration mill, and a ball mill, and then through a transportation module and an airflow injection module to generate dust particles. It is difficult to achieve an average particle size less than 10 μm for the dust particles generated by this type of process grinding, and the grinding process is very complex, time-consuming, and labor-intensive, often requiring multiple operators to complete. The quality of each grinding is very low, making it unsuitable for experimental platform systems with high dust production requirements, and unable to adjust the humidity of the airflow containing dust particles.

### SUMMARY

In view of the above-mentioned problems in the existing technology, the objective of the present disclosure is to provide a precise concentration generating device and a dust generation simulation method for dust particles.

The objective of the present disclosure can be achieved through the following technical solutions: A precise concentration generating device for dust particles, including a smoke cake particle generator and a water tank, wherein a feeding port is set at a top of the smoke cake particle generator, and a discharging port is set at a bottom of the smoke cake particle generator; the discharging port is connected to a material conveying pipeline, an initial end of the material conveying pipeline is connected to a material conveying fan, the material conveying fan is electrically controlled by a fan controller, and a terminal end of the material conveying pipeline is connected to a cyclone chamber of a cyclone cylinder; a high-temperature heating tube is set at a bottom of the cyclone chamber, and the high-temperature heating tube is electrically controlled by a temperature controller; a dust outlet is set at a top of the cyclone cylinder, and an air-flow regulator is set inside the dust outlet; the bottom of the cyclone cylinder is provided with a slag discharge port, and the slag discharge port is hinged with a slag discharge gate; the water tank is connected to a water distribution pipe, a first branch pipeline of the water distribution pipe is connected in series with a high-pressure pump, an end of the first branch pipeline is connected to at least four nozzles, and the at least four nozzles extend into the cyclone chamber of the cyclone cylinder; and a valve is connected in series on a second branch pipeline of the water distribution pipe, at least one water outlet is set at an end of the second branch pipeline, and the water outlet is connected to the cyclone chamber of the cyclone cylinder.

In the precise concentration generating device for dust particles mentioned above, the smoke cake particle generator includes a casing with a crushing chamber, a crushing motor is installed on the casing, and the crushing motor is electrically connected by a motor controller; a rotation shaft driven by the crushing motor extends into the crushing chamber of the casing, a plurality of crushing blades are arranged in a middle of the rotation shaft along a circumferential direction, and a plurality of stirring blades are arranged at a bottom of the rotation shaft along the circumferential direction; a partition plate is arranged in the crushing chamber, the partition plate is driven to open and close by a magnetic adjuster, and the partition plate is located between the crushing blades and the stirring blades.

In the precise concentration generating device for dust particles mentioned above, the partition plate includes a fixed plate in a polygonal shape, and a plurality of open-close movable plates flexibly connected around a periphery of the fixed plate; the plurality of open-close movable plates are assembled to form an outer contour that matches an cross-section of the crushing chamber; magnets are set on an outer edge of each of the plurality of open-close movable plates, the magnetic adjuster is provided with magnetic coils corresponding one-to-one with the magnets, and the magnetic coils form magnetic attraction or magnetic repulsion with the magnets.

In the precise concentration generating device for dust particles mentioned above, the fixed plate is a square plate, each of the plurality of open-close movable plates is a curved plate, a straight edge of the curved plate is rotatably connected to a straight edge of the square plate through a hinge, and a curved edge of the curved plate matches with a curve of an inner wall of a circumference of the casing; each of the plurality of open-close movable plates is provided with a limit ring, and the limit ring is an arc bending rod; one end of the arc bending rod is fixedly connected to a bottom side of the corresponding open-close movable plate, an other end of the arc bending rod faces the square plate to form a limiting end, and the limiting end is pressed against a bottom side of the square plate, so that the corresponding open-close movable plate forms a downward inclination angle with the horizontal plane.

In the precise concentration generating device for dust particles mentioned above, a mounting hole is opened in a middle of the fixed plate, a bearing is installed in the mounting hole, and the rotation shaft passes through the bearing to form a rotational connection.

In the precise concentration generating device for dust particles mentioned above, a pressure gauge is connected in series with the first branch pipeline, and a flow meter is connected in series with the second branch.

In the precise concentration generating device for dust particles mentioned above, the high-temperature heating tube uses a stainless steel tube, the high-temperature heating tube is arranged as wrapping in multiple circles around the circumference, and both ends of the high-temperature heating tube are connected to a temperature controller.

A dust generation simulation method of a precise concentration generating device of dust particles, which uses the the precise concentration generating device of dust particles mentioned above, wherein the dust generation simulation method includes the following steps:
S1, firstly, turning on the high-temperature heating tube to reach a preset temperature and preheat for 2-3 minutes; then opening the valve to allow water in the water tank to flow into the cyclone cylinder through the water outlet;
S2, opening the feeding port, putting several smoke cakes into the smoke cake particle generator, then closing the feeding port, at this time, the partition plate is in a closed state, and several smoke cakes are trapped above the partition plate;
S3, starting the crushing motor to drive the rotation shaft to rotate the crushing blades for operation, and the crushing blades crush the smoke cakes to a required particle size at a speed of 5000 r/min to 40000 r/min, then controlling the crushing motor to stop; starting the material conveying fan, and adjusting a wind speed through the fan controller; restarting the crushing motor, and controlling the rotation shaft through the motor controller to drive the stirring blades at a speed of 10 r/min to 80 r/min; adjusting magnetic poles of the magnetic coils to be the same as magnetic poles of the magnets to use the magnetic repulsion of the same poles to push the open-close movable plates downwards, forming a connecting gap between a periphery of the fixed plate and an inner wall of the casing; the smoke cake particles after being crushed are subjected to gravity and enter a lower part of the partition plate through the connecting gap, and then continue to fall into the material conveying pipeline through the rotation of the stirring blades; when all the smoke cake particles are discharged into the material conveying pipeline, adjusting the magnetic poles of the magnetic coil to be opposite to the magnetic poles of the magnets, and the open-close movable plates are sucked and closed by the magnetic attraction of the different poles, so that the edge of the open-close movable plates fit with the inner wall of the casing to form a cross section seal;
S4, blowing all the smoke cake particles in the material conveying pipeline into the cyclone cylinder under a wind force of the material conveying fan, the cyclone cylinder generates a high-speed outer swirling airflow, and the smoke cake particles inside the outer swirling airflow are simultaneously subjected to two radial forces, one is a centrifugal force generated by a tangential velocity of the outer swirling airflow to cause the smoke cake particles to be pushed outward; another one is a centripetal force generated by a radial velocity of the outer swirling airflow to cause the smoke cake particles to be pushed inward; in an outer swirling airflow, the centrifugal force generated by the tangential velocity is greater than the centripetal force generated by the radial velocity for large mass smoke cake particles, so that the smoke cake particles are transported to an inner wall of the cyclone cylinder by an inertial centrifugal force, and the smoke cake particles fall under an influence of the outer swirling airflow;
the smoke cake particles are ignited under an action of high temperature when the smoke cake particles fall to the high-temperature heating tube, burning to produce fine dust particles and smoke cake residue; the centrifugal force generated by the tangential velocity is smaller than the centripetal force generated by the radial velocity for small mass smoke cake particles, so that the dust particles enter an inner swirling upward airflow under the action of centripetal force, then the dust particles uniformly spiral upward along an axial direction of the cyclone cylinder, while the remaining smoke cake residue slides down to the slag discharge port due to the centrifugal force caused by large mass;
S5, water flowing out from the water outlet slides down the inner wall of the cyclone cylinder under an action of gravity and reaches the high-temperature heating tube, performing a high-temperature heating to vaporize the water into water vapor, and the water vapor is uniformly spiraling upwards driven by the inner swirling upward airflow; during the upward process, the water vapor is fully mixed with dust particles, increasing humidity of airflow containing dust particles;
S6, the airflow containing dust particles rises to the dust outlet, then forming a dust generating airflow with consistent flow direction and stable flow velocity through the air-flow regulator; burning continues until the preset time, and smoke cake residue accumulates at the slag discharge port; regularly opening the slag discharge gate to clean the smoke cake residue.

In the dust generation simulation method of the precise concentration generating device for dust particles mentioned above, the high-temperature heating tube causes an increase in temperature at a lower part of the cyclone chamber during heating, resulting in a temperature difference between an upper part and the lower part of the cyclone chamber, so that the lower part of the cyclone chamber is in a low-pressure state, causing a pressure difference between the upper part and the lower part of the cyclone chamber; at the same time, the high-pressure outer swirling airflow from top to bottom reaches the high-temperature heating tube, gradually being heating up, then flows back into the inner swirling upward airflow, forming a pressure difference from an outside to an inside where the outer swirling airflow has a low temperature and high pressure, and the inner swirling upward airflow has a high temperature and low pressure.

In the dust generation simulation method of the precise concentration generating device for dust particles mentioned above, after a dust generation airflow simulation is completed, turning off the crushing motor and the high-temperature heating tube, opening the slag discharge gate, and starting the high-pressure pump, so that the water in the water tank passes through the first branch pipeline, then is uniformly sprayed into the cyclone chamber through a plurality of nozzles to form a high-pressure mist field, to wash the inner wall of the cyclone cylinder to clean the attached particle residue under the action of the high-speed outer swirling airflow in the cyclone chamber, cleaning 2-3 times in total and each time for no less than 3 minutes; after cleaning is completed, turning off the high-pressure pump; the material conveying fan continues to blow air for at least 10 minutes, and the airflow enters the cyclone chamber through the material conveying pipeline to dry the inner wall of the cyclone cylinder; after the drying is completed, turning off the material conveying fan and closing the slag discharge gate.

Compared with existing technologies, the precise concentration generating device and the dust generation simulation method for dust particles have the following advantageous effects:

1. This device can achieve powder processing of smoke cakes through high-speed rotating crushing blades, forming smoke cake particles. With an integrated coaxial design, the quantitative and continuous transportation of smoke cake particles is achieved, thereby reducing the volume of the entire device.

2. By utilizing the high-speed rotating airflow inside the cyclone cylinder, the smoke cake particles are uniformly and continuously transported to the bottom of the cyclone cylinder under centrifugal force. Through high-temperature heating, the smoke cake particles are burned to produce uniformly concentrated dust particles, with an average particle size of less than 10 μm, effectively simulating the diffusion of fine dust particles in coal mining environments. It also reduces the influence of frictional resistance on the rotating airflow by generating heat and pressure difference.

3. Dust particles are emitted through an air-flow regulator to achieve stable emission of jet airflow without swirling flow. A certain amount of water flows out through the water outlet, and the water flows into the high-temperature heating tube for vaporizing. The vaporized water vapor is more uniform under the action of swirling flow. According to the requirements of simulating dust particle scenarios, humidity regulation of dust particle jet airflow is achieved.

4. The added nozzle effectively purifies impurities inside the cyclone cylinder under the action of the swirling flow, making the cleaning operation convenient and thorough, without affecting the next particle concentration simulation.

5. This technique can efficiently utilize smoke cake raw materials, and the technical method is simple to operate. One operator can complete all the processes without the need for pre-treatment of smoke cake or coal rock samples, saving time and effort. Moreover, the cost of using smoke cake is relatively low, effectively reducing experimental costs.

In summary, compared to the direct combustion of smoke cakes to generate dust particles, the present disclosure produces a more uniform, precise, and controllable concentration of dust particles, and can control the start and stop of dust particle generation at any time, which is suitable for experimental simulation requirements in various coal mine dust particle environments. That is to say, it can achieve precise adjustment of dust particle concentration, effective humidity control, convenient equipment cleaning, and has the advantages of good economy, wide applicability, and broad application prospects.

### BRIEF DESCRIPTION OF THE DRAWINGS

FIG. 1 shows the overall structure of the precise concentration generating device for dust particles.

FIG. 2 is an enlarged front view of the partition plate in the present disclosure.

FIG. 3 is an enlarged partial view of the partition plate in the present disclosure.

FIG. 4 is an enlarged top view of the partition plate in the present disclosure.

FIG. 5 is an enlarged view of the high-temperature heating tube in the present disclosure.

FIG. 6 is an enlarged view of the air-flow regulator in the present disclosure.

Reference numbers in the drawings, 1. smoke cake particle generator; 2. crushing motor; 3. motor controller; 4. rotation shaft; 5. crushing blade; 6. partition plate; 6a. fixed plate; 6b. hinge; 6c. open-close movable plate; 6d, magnet; 6e. limit ring; 7. magnetic adjuster; 7a. magnetic coil; 8. stirring blade; 9. material conveying fan; 10. fan controller; 11. material conveying pipeline; 12. cyclone cylinder; 13. high-temperature heating tube; 14 temperature controller; 15. slag discharge port; 16. air-flow regulator; 16a, air vent; 17. water tank; 18. first branch pipeline; 19. high-pressure pump; 20. pressure gauge; 21. nozzle; 22. second branch pipeline; 23. flow meter; 24. valve; 25. water outlet; A—feeding port; B—slag discharge port; C—cyclone chamber; D—dust outlet; E—casing with a crushing chamber.

### DETAILED DESCRIPTION OF THE EMBODIMENT

The present invention will be further described with reference to the drawings and preferred embodiments. It should be understood that these embodiments are only used to illustrate the present invention, but the present invention is not limited thereto.

### Embodiment 1

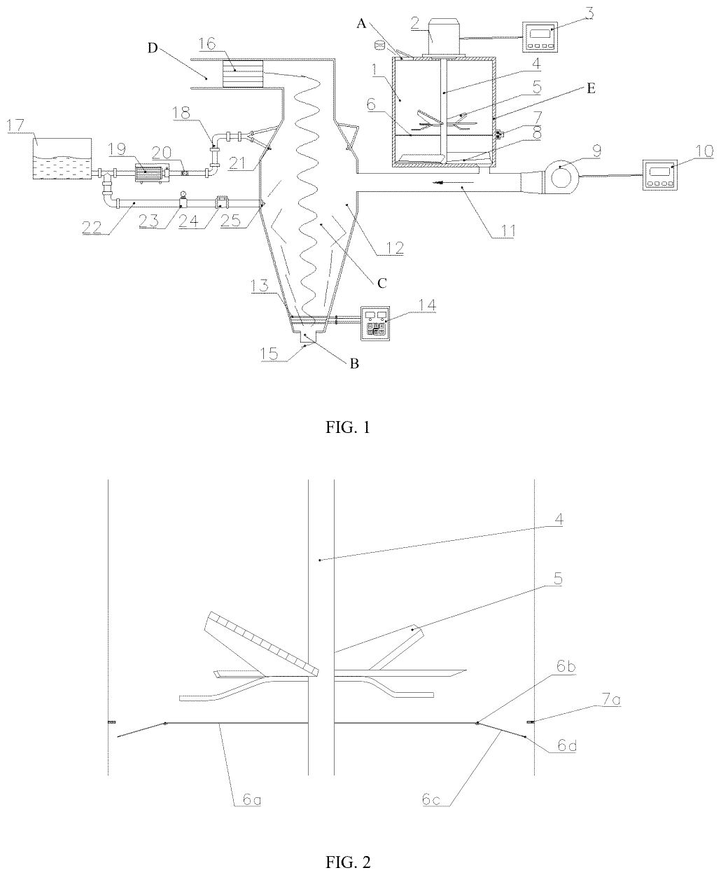

As shown in FIG. 1-FIG. 6, a precise concentration generating device for dust particles is provided, which includes a smoke cake particle generator 1 and a water tank 17, wherein a feeding port is set at the top of the smoke cake particle generator 1, and a discharging port is set at the bottom of the smoke cake particle generator 1; the discharging port is connected to a material conveying pipeline 11, an initial end of the material conveying pipeline 11 is connected to a material conveying fan 9, the material conveying fan 9 is electrically controlled by a fan controller 10, and a terminal end of the material conveying pipeline 11 is connected to a cyclone chamber of a cyclone cylinder 12; a high-temperature heating tube 13 is set at the bottom of the cyclone chamber, and the high-temperature heating tube 13 is electrically controlled by a temperature controller 14; a dust outlet is set at the top of the cyclone cylinder 12, and an air-flow regulator 16 is set inside the dust outlet; and the bottom of the cyclone cylinder 12 is provided with a slag discharge port, and the slag discharge port is hinged with a slag discharge gate 15. As shown in FIG. 1, the water tank 17 is connected to a water distribution pipe, a first branch pipeline 18 of the water distribution pipe is connected in series with a high-pressure pump 19, and a pressure gauge 20 is connected in series with the first branch pipeline 18, and an end of the first branch pipeline 18 is connected to at least four nozzles 21, and the at least four nozzles 21 extend into the cyclone chamber of the cyclone cylinder 12. The actual liquid pressure in the first branch pipeline 18 is measured through the pressure gauge 20, thereby adjusting the power of the high-pressure pump 19 according to the injection pressure requirements to ensure that the actual injection intensity and strength meet the required standards.

A flow meter 23 is connected in series with a second branch 22, a valve 24 is connected in series on the second branch pipeline 22, at least one water outlet 25 is set at an end of the second branch pipeline 22, and the water outlet 25 is connected to the cyclone chamber of the cyclone cylinder 12. The actual liquid flow rate in the second branch pipeline 22 is measured through the flow meter 23, thereby adjusting the opening degree of valve 24 according to the water inlet requirements to maintain the actual water inlet at the set level.

The water tank 17 provides water source for the water outlet 25 and the nozzles 21 through a water distribution pipe, and injects water into the cyclone chamber through the water outlet 25 to change the humidity of the output airflow containing dust particles. By spraying high-pressure mist field into the cyclone chamber through the nozzles 21, and effectively cleaning the particle residue on the inner wall of cyclone cylinder 12 under the action of high-speed external airflow, it avoids the impact of particle residue shedding on subsequent uniform particle concentration. The fan controller 10 can adjust the wind speed of the material conveying fan 9 to achieve a change in the inlet wind speed of the cyclone cylinder 12, avoiding the accumulation of smoke cake particles in the material conveying pipeline 11 due to excessively low wind speed. The cyclone cylinder 12 is a variable diameter cylinder structure composed of a cylindrical structure and a conical structure. Specifically, the middle of cyclone cylinder 12 is the middle cylinder, with the upper part of the middle cylinder connected to the upright cone tube and the lower part of the middle cylinder connected to the inverted cone tube. The small diameter opening at the top of the upright cone tube is connected to the dust outlet at a right angle, and the small diameter opening at the bottom of the inverted cone tube forms the slag discharge port. As shown in FIG. 6, the air-flow regulator 16 is equipped with multiple air holes 16a inside, which are used to reduce the swirling characteristics of the airflow containing dust particles due to the inner swirling upward airflow, so that the airflow containing dust particles presents a stable and consistent flow direction, in order to output uniform and directional dust particles.

As shown in FIG. 1 and FIG. 2, the smoke cake particle generator 1 includes a casing with a crushing chamber, a crushing motor 2 is installed on the casing, and the crushing motor 2 is electrically connected by a motor controller 3. A connected rotation shaft 4 driven by the crushing motor 2 extends into the crushing chamber of the casing, a plurality of crushing blades 5 are arranged in the middle of the rotation shaft 4 along the circumferential direction, and a plurality of stirring blades 8 are arranged at the bottom of the rotation shaft 4 along the circumferential direction. A partition plate 6 is arranged in the crushing chamber, the partition plate 6 is driven to open and close by a magnetic adjuster 7, and the partition plate 6 is located between the crushing blades 5 and the stirring blades 8.

The crushing blades 5 and the stirring blades 8 adopt an integrated coaxial design, fully utilizing the torque of the crushing motor 2, thereby reducing the volume of the entire equipment.

By regulating the rotational speed of the rotation shaft 4 through the motor controller 3, the quality of the transported smoke cake particles is controlled, thereby controlling the concentration of generated dust particles. The speed range for the crushing blades 5 during operation is 5000 r/min to 4000 r/min, while the speed range for stirring blades 8 during operation is 10 r/min to 80 r/min. The crushing space is separated from the stirring space by the partition plate 6, and the partition plate 6 is controlled to open by the magnetic adjuster 7. The smoke cake particles fall due to gravity, and the smoke cake particles are uniformly dropped into the lower conveying pipeline 11 under the driving of the stirring blades 8, ensuring the continuity and stability transportation of dust particles.

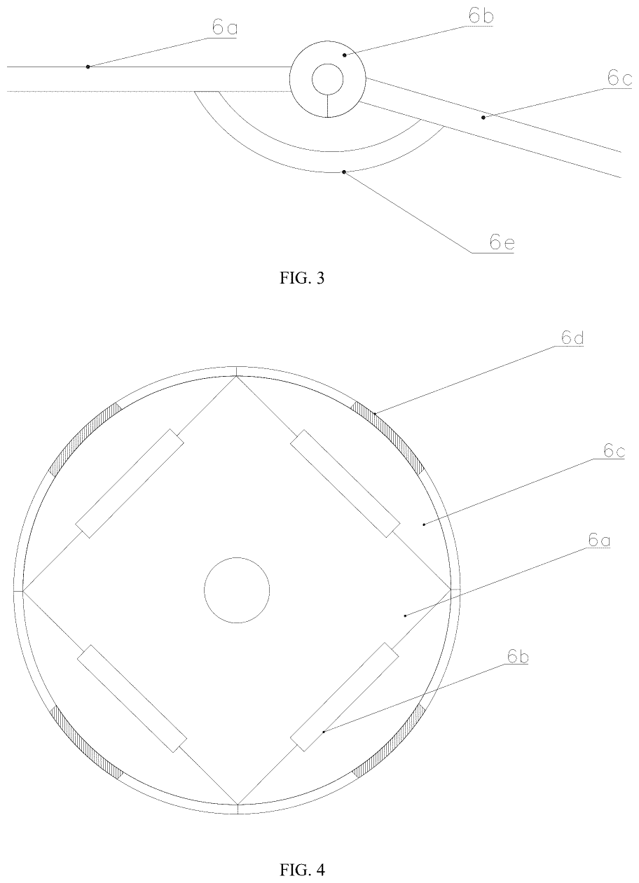

As shown in FIG. 3 and FIG. 4, the partition plate 6 includes a fixed plate 6a in a polygonal shape, and a plurality of open-close movable plates 6c flexibly connected around the periphery of the fixed plate 6a. The plurality of open-close movable plates 6c are assembled to form the outer contour that matches the cross-section of the crushing chamber of the smoke cake particle generator 1. Magnets 6d are set on the outer edge of each of the plurality of open-close movable plates 6c, the magnetic adjuster 7 is provided with magnetic coils 7a corresponding one-to-one with the magnets 6d, and the magnetic coils 7a form magnetic attraction or magnetic repulsion with the magnets 6d.

The number of magnetic coils 7a is consistent with the number of open-close movable plates 6c, and the magnetic coils 7a correspond one-to-one to the open-close movable plates 6c set on the inner wall of the casing. Based on the principle of electromagnet, the polarity of the magnetic pole can be changed according to demand by manually adjusting the direction of the current.

Through the operability of the open-close movable plate 6c, the integrated coaxial design of the smoke cake particle generator 1 can be achieved, reducing the set volume. At the same time, the opening and closing of the open-close movable plates 6c are controlled by the magnetic adjuster 7, achieving the connection or isolation between the crushing area and the stirring area, with convenient operation and high work efficiency.

The fixed plate 6a is a square plate, each of the plurality of open-close movable plates 6c is a curved plate, a straight edge of the curved plate is rotatably connected to a straight edge of the square plate through a hinge 6b, and a curved edge of the curved plate matches with a curve of the inner wall of a circumference of the casing. Each of the plurality of open-close movable plates 6c is provided with a limit ring 6e, and the limit ring 6e is an arc bending rod. One end of the arc bending rod is fixedly connected to the bottom side of the corresponding open-close movable plate, the other end of the arc bending rod faces the square plate to form a limiting end, and the limiting end is pressed against the bottom side of the square plate, so that the curved plate forms a downward inclination angle with the horizontal plane.

The use of a cylindrical shell for the casing facilitates uniform and consistent rotation, crushing, and stirring. The fixed plate 6a can also adopt other equilateral polygon structures, with a curved plate on each straight edge, so that when all curved plates are flattened, the internal cross-section of the cylindrical shell is sealed. By Weld a limit ring 6e on the open-close movable plate 6c, it ensures that the maximum falling angle α of the open-close movable plate 6c does not exceed 20°, and this ensures that when the magnets 6d and the magnetic coils 7a are attracted to each other with opposite poles, the distance between them is short enough to be closed by magnetic force. That is to say, when the partition plate 6 is in the open state, the open-close movable plate 6c is mounted on the limit ring 6e due to repulsive magnetic force, forming an inclined state to shorten the distance between the magnet 6d and the magnetic coil 7a, which is conducive to the magnetic adjuster 7 driving the magnet 6d to engage for close under magnetic force.

A mounting hole is opened in the middle of the fixed plate 6a, a bearing is installed in the mounting hole, and the rotation shaft 4 passes through the bearing to form a rotational connection. By assembling the bearing, the rotation shaft 4 can pass through the partition plate 6 without interfering with the rotation shaft 4 to drive the crushing blades 5 and stirring blades 8 to rotate for operation.

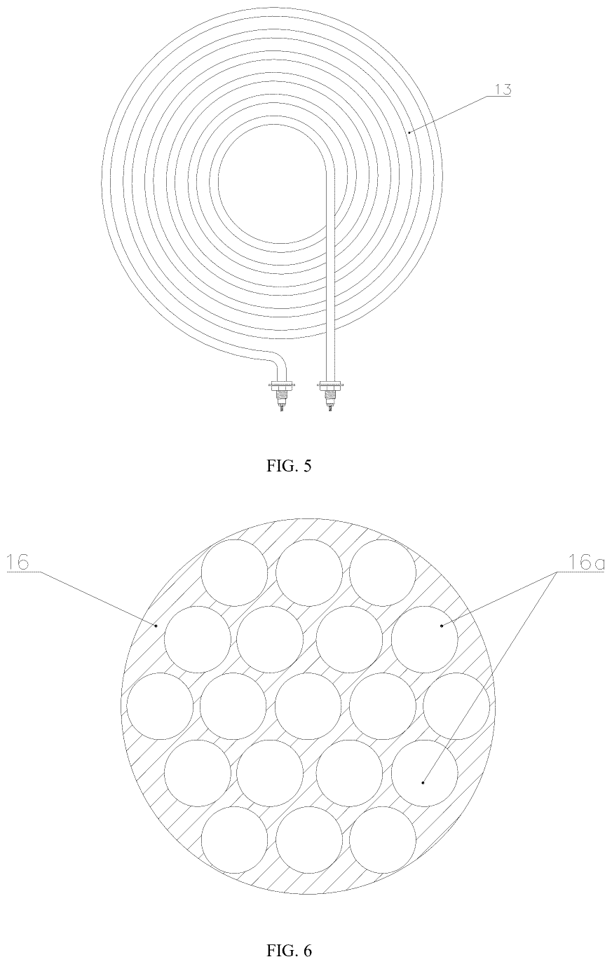

As shown in FIG. 5, the high-temperature heating tube 13 uses a stainless steel tube, the high-temperature heating tube 13 is arranged as wrapping in multiple circles around the circumference, and both ends of the high-temperature heating tube 13 are connected to a temperature controller 14. The temperature of the high-temperature heating tube 13 is regulated by the temperature controller 14 to achieve the heating and evaporation of water in the cyclone chamber and the ignition of smoke cake particles.

### Embodiment 2

Based on Embodiment 1, the differences of this embodiment are:

A dust generation simulation method of a precise concentration generating device of dust particles, which uses the the precise concentration generating device of dust particles mentioned above, wherein the dust generation simulation method includes the following steps:

S1, firstly, turning on the high-temperature heating tube 13 to reach a preset temperature and preheat for 2-3 minutes; then opening the valve 24 to allow water in the water tank 17 to flow into the cyclone cylinder 12 through the water outlet 25.

S2, opening the feeding port, putting several smoke cakes into the smoke cake particle generator 1, then closing the feeding port, at this time, the partition plate 6 is in a closed state, and several smoke cakes are trapped above the partition plate 6.

S3, starting the crushing motor 2 to drive the rotation shaft 4 to rotate the crushing blades 5 for operation, and the crushing blades 5 crush the smoke cakes to a required particle size at a speed of 5000 r/min to 40000 r/min, then controlling the crushing motor 2 to stop; starting the material conveying fan 9, and adjusting a wind speed through the fan controller 10; restarting the crushing motor 2, and controlling the rotation shaft 4 through the motor controller 3 to drive the stirring blades 8 at a speed of 10 r/min to 80 r/min; adjusting magnetic poles of the magnetic coils 7a to be the same as magnetic poles of the magnets 6d to use the magnetic repulsion of the same poles to push the open-close movable plates 6c downwards, forming a connecting gap between the periphery of the fixed plate 6a and the inner wall of the casing; the smoke cake particles after being crushed are subjected to gravity and enter a lower part of the partition plate 6 through the connecting gap, and then continue to fall into the material conveying pipeline 11 through the rotation of the stirring blades 8; when all the smoke cake particles are discharged into the material conveying pipeline 11, adjusting the magnetic poles of the magnetic coil 7a to be opposite to the magnetic poles of the magnets 6d, and the open-close movable plates 6c are sucked and closed by the magnetic attraction of the different poles, so that the edge of the open-close movable plates 6c fit with the inner wall of the casing to form a cross section seal.

S4, blowing all the smoke cake particles in the material conveying pipeline 11 into the cyclone cylinder 12 under a wind force of the material conveying fan 9, the cyclone cylinder 12 generates a high-speed outer swirling airflow, and the smoke cake particles inside the outer swirling airflow are simultaneously subjected to two radial forces, one is a centrifugal force generated by a tangential velocity of the outer swirling airflow to cause the smoke cake particles to be pushed outward; another one is a centripetal force generated by a radial velocity of the outer swirling airflow to cause the smoke cake particles to be pushed inward; in an outer swirling airflow, the centrifugal force generated by the tangential velocity is greater than the centripetal force generated by the radial velocity for large mass smoke cake particles, so that the smoke cake particles are transported to an inner wall of the cyclone cylinder 12 by an inertial centrifugal force, and the smoke cake particles fall under an influence of the outer swirling airflow.

the smoke cake particles are ignited under an action of high temperature when the smoke cake particles fall to the high-temperature heating tube 13, burning to produce fine dust particles and smoke cake residue; the centrifugal force generated by the tangential velocity is smaller than the centripetal force generated by the radial velocity for small mass smoke cake particles, so that the dust particles enter an inner swirling upward airflow under the action of centripetal force, then the dust particles uniformly spiral upward along an axial direction of the cyclone cylinder 12, while the remaining smoke cake residue slides down to the slag discharge port due to the centrifugal force caused by large mass; by adopting the design of cyclone cylinder 12, the incoming smoke cake particles can be uniformly mixed under the influence of outer swirling airflow, while dust particles with a certain concentration can be uniformly output under the action of inner swirling upward airflow.

S5, water flowing out from the water outlet 25 slides down the inner wall of the cyclone cylinder 12 under an action of gravity and reaches the high-temperature heating tube 13, performing a high-temperature heating to vaporize the water into water vapor, and the water vapor is uniformly spiraling upwards driven by the inner swirling upward airflow; during the upward process, the water vapor is fully mixed with dust particles, increasing humidity of airflow containing dust particles.

S6, the airflow containing dust particles rises to the dust outlet, then forming a dust generating airflow with consistent flow direction and stable flow velocity through the air-flow regulator 16; burning continues until the preset time, and smoke cake residue accumulates at the slag discharge port; regularly opening the slag discharge gate 15 to clean the smoke cake residue.

The high-temperature heating tube 13 causes an increase in temperature at the lower part of the cyclone chamber during heating, resulting in a temperature difference between the upper part and the lower part of the cyclone chamber, so that the lower part of the cyclone chamber is in a low-pressure state, causing a pressure difference between the upper part and the lower part of the cyclone chamber; at the same time, the high-pressure outer swirling airflow from top to bottom reaches the high-temperature heating tube 13, gradually being heating up, then flows back into the inner swirling upward airflow, forming a pressure difference from the outside to the inside where the outer swirling airflow has a low temperature and high pressure, and the inner swirling upward airflow has a high temperature and low pressure.

Driven by the pressure difference between the top and bottom, as well as the pressure difference between the inside and outside of the cyclone cylinder 12, the downward and inward flow velocity of the gas is accelerated, increasing the kinetic energy of the gas. And driven by thermal effects, it reduces the energy consumption caused by frictional resistance along the inner wall of the cyclone cylinder 12 due to the outer swirling airflow, thereby reducing the wind pressure requirements on the material conveying fan 9 and indirectly reducing the noise pollution caused by the high-pressure fan.

After a dust generation airflow simulation is completed, turning off the crushing motor 2 and the high-temperature heating tube 13, opening the slag discharge gate 15, and starting the high-pressure pump 19, so that the water in the water tank 17 passes through the first branch pipeline 18, then is uniformly sprayed into the cyclone chamber through a plurality of nozzles 21 to form a high-pressure mist field, to wash the inner wall of the cyclone cylinder 12 to clean the attached particle residue under the action of the high-speed outer swirling airflow in the cyclone chamber, cleaning 2-3 times in total and each time for no less than 3 minutes; after cleaning is completed, turning off the high-pressure pump 19; the material conveying fan 9 continues to blow air for at least 10 minutes, and the airflow enters the cyclone chamber through the material conveying pipeline 11 to dry the inner wall of the cyclone cylinder 12; after the drying is completed, turning off the material conveying fan 9 and closing the slag discharge gate 15.

In the present invention, the terms “first,” “second,” are merely for the purpose of description, but cannot be understood as indicating or implying relative importance. The term “multiple” means two or more unless otherwise explicitly defined. The terms “mount,” “connect with,” “connect,” “fix,” and the like shall be understood in a broad sense. For example, “connect” may mean being fixedly connected, detachably connected, or integrally connected; and “connect with” may mean being directly connected or indirectly connected through an intermediary. For those of ordinary skill in the art, specific meanings of the above terms in the present invention can be understood according to specific situations.

In the description of the present invention, it should be understood that if orientation or position relations indicated by the terms such as “upper,” “lower,” “left,” “right,” “front,” “back,” and the like are based on the orientation or position relations shown in the drawings, and the terms are intended only to facilitate the description of the present invention and simplify the description, rather than indicating or implying that the apparatus or element referred to must have a particular orientation and be constructed and operated in the particular orientation, and therefore cannot be construed as a limitation on the present invention.

Certainly, the above descriptions are merely preferred embodiments of the present disclosure. The present disclosure is not limited to the above embodiments listed. It should be noted that, all equivalent replacements and obvious variations made by any person skilled in the art under the teaching of the specification fall within the essential scope of the specification and shall be protected by the present disclosure.

What is claimed is:

1. A precise concentration generating device for dust particles, comprising a smoke cake particle generator and a water tank, wherein a feeding port is set at a top of the smoke cake particle generator, and a discharging port is set at a bottom of the smoke cake particle generator; the discharging port is connected to a material conveying pipeline, an initial end of the material conveying pipeline is connected to a material conveying fan, the material conveying fan is electrically controlled by a fan controller, and a terminal end of the material conveying pipeline is connected to a cyclone chamber of a cyclone cylinder; a high-temperature heating tube is set at a bottom of the cyclone chamber, and the high-temperature heating tube is electrically controlled by a temperature controller; a dust outlet is set at a top of the cyclone cylinder, and an air-flow regulator is set inside the dust outlet; the bottom of the cyclone cylinder is provided with a slag discharge port, and the slag discharge port is hinged with a slag discharge gate; the water tank is connected to a water distribution pipe, a first branch pipeline of the water distribution pipe is connected in series with a high-pressure pump, an end of the first branch pipeline is connected to at least four nozzles, and the at least four nozzles extend into the cyclone chamber of the cyclone cylinder; and a valve is connected in series on a second branch pipeline of the water distribution pipe, at least one water outlet is set at an end of the second branch pipeline, and the water outlet is connected to the cyclone chamber of the cyclone cylinder.

2. The precise concentration generating device for dust particles as claimed in claim 1, wherein the smoke cake particle generator comprises a casing with a crushing chamber, a crushing motor is installed on the casing, and the crushing motor is electrically connected by a motor controller; a rotation shaft driven by the crushing motor extends into the crushing chamber of the casing, a plurality of crushing blades are arranged in a middle of the rotation shaft along a circumferential direction, and a plurality of stirring blades are arranged at a bottom of the rotation shaft along the circumferential direction; a partition plate is arranged in the crushing chamber, the partition plate is driven to open and close by a magnetic adjuster, and the partition plate is located between the crushing blades and the stirring blades.

3. The precise concentration generating device for dust particles according to claim 2, wherein the partition plate comprises a fixed plate in a polygonal shape, and a plurality of open-close movable plates flexibly connected around a periphery of the fixed plate; the plurality of open-close movable plates are assembled to form an outer contour that matches an cross-section of the crushing chamber; magnets are set on an outer edge of each of the plurality of open-close movable plates, the magnetic adjuster is provided with magnetic coils corresponding one-to-one with the magnets, and the magnetic coils form magnetic attraction or magnetic repulsion with the magnets.

4. The precise concentration generating device for dust particles according to claim 3, wherein the fixed plate is a square plate, each of the plurality of open-close movable plates is a curved plate, a straight edge of the curved plate is rotatably connected to a straight edge of the square plate through a hinge, and a curved edge of the curved plate matches with a curve of an inner wall of a circumference of the casing; each of the plurality of open-close movable plates is provided with a limit ring, and the limit ring is an arc bending rod; one end of the arc bending rod is fixedly connected to a bottom side of the corresponding open-close movable plate, an other end of the arc bending rod faces the square plate to form a limiting end, and the limiting end is pressed against a bottom side of the square plate, so that the corresponding open-close movable plate forms a downward inclination angle with the horizontal plane.

5. The precise concentration generating device for dust particles according to claim 3, wherein a mounting hole is opened in a middle of the fixed plate, a bearing is installed in the mounting hole, and the rotation shaft passes through the bearing to form a rotational connection.

6. The precise concentration generating device for dust particles as claimed in claim 3, wherein a pressure gauge is connected in series with the first branch pipeline, and a flow meter is connected in series with the second branch.

7. The precise concentration generating device for dust particles according to claim 3, wherein the high-temperature heating tube uses a stainless steel tube, the high-temperature heating tube is arranged as wrapping in multiple circles around the circumference, and both ends of the high-temperature heating tube are connected to a temperature controller.

8. A dust generation simulation method of the precise concentration generating device of dust particles as claimed in claim 7, wherein the dust generation simulation method comprises the following steps:
S1, firstly, turning on the high-temperature heating tube to reach a preset temperature and preheat for 2-3 minutes; then opening the valve to allow water in the water tank to flow into the cyclone cylinder through the water outlet;
S2, opening the feeding port, putting several smoke cakes into the smoke cake particle generator, then closing the feeding port, at this time, the partition plate is in a closed state, and several smoke cakes are trapped above the partition plate;
S3, starting the crushing motor to drive the rotation shaft to rotate the crushing blades for operation, and the crushing blades crush the smoke cakes to a required particle size at a speed of 5000 r/min to 40000 r/min, then controlling the crushing motor to stop; starting the material conveying fan, and adjusting a wind speed through the fan controller; restarting the crushing motor, and controlling the rotation shaft through the motor controller to drive the stirring blades at a speed of 10 r/min to 80 r/min; adjusting magnetic poles of the magnetic coils to be the same as magnetic poles of the magnets to use the magnetic repulsion of the same poles to push the open-close movable plates downwards, forming a connecting gap between a periphery of the fixed plate and an inner wall of the casing; the smoke cake particles after being crushed are subjected to gravity and enter a lower part of the partition plate through the connecting gap, and then continue to fall into the material conveying pipeline through the rotation of the stirring blades; when all the smoke cake particles are discharged into the material conveying pipeline, adjusting the magnetic poles of the magnetic coil to be opposite to the magnetic poles of the magnets, and the open-close movable plates are sucked and closed by the magnetic attraction of the different poles, so that the edge of the open-close movable plates fit with the inner wall of the casing to form a cross section seal;
S4, blowing all the smoke cake particles in the material conveying pipeline into the cyclone cylinder under a wind force of the material conveying fan, the cyclone cylinder generates a high-speed outer swirling airflow, and the smoke cake particles inside the outer swirling airflow are simultaneously subjected to two radial forces, one is a centrifugal force generated by a tangential velocity of the outer swirling airflow to cause the smoke cake particles to be pushed outward; another one is a centripetal force generated by a radial velocity of the outer swirling airflow to cause the smoke cake particles to be pushed inward;
in an outer swirling airflow, the centrifugal force generated by the tangential velocity is greater than the centripetal force generated by the radial velocity for large mass smoke cake particles, so that the smoke cake particles are transported to an inner wall of the cyclone cylinder by an inertial centrifugal force, and the smoke cake particles fall under an influence of the outer swirling airflow;
the smoke cake particles are ignited under an action of high temperature when the smoke cake particles fall to the high-temperature heating tube, burning to produce fine dust particles and smoke cake residue; the centrifugal force generated by the tangential velocity is smaller than the centripetal force generated by the radial velocity for small mass smoke cake particles, so that the dust particles enter an inner swirling upward airflow under the action of centripetal force, then the dust particles uniformly spiral upward along an axial direction of the cyclone cylinder, while the remaining smoke cake residue slides down to the slag discharge port due to the centrifugal force caused by large mass;
S5, water flowing out from the water outlet slides down the inner wall of the cyclone cylinder under an action of gravity and reaches the high-temperature heating tube, performing a high-temperature heating to vaporize the water into water vapor, and the water vapor is uniformly spiraling upwards driven by the inner swirling upward airflow; during the upward process, the water vapor is fully mixed with dust particles, increasing humidity of airflow containing dust particles;
S6, the airflow containing dust particles rises to the dust outlet, then forming a dust generating airflow with consistent flow direction and stable flow velocity through the air-flow regulator; burning continues until the preset time, and smoke cake residue accumulates at the slag discharge port; regularly opening the slag discharge gate to clean the smoke cake residue.

9. The dust generation simulation method of the precise concentration generating device for dust particles as claimed in claim 8, wherein the high-temperature heating tube causes an increase in temperature at a lower part of the cyclone chamber during heating, resulting in a temperature difference between an upper part and the lower part of the cyclone chamber, so that the lower part of the cyclone chamber is in a low-pressure state, causing a pressure difference between the upper part and the lower part of the cyclone chamber; at the same time, the high-pressure outer swirling airflow from top to bottom reaches the high-temperature heating tube, gradually being heating up, then flows back into the inner swirling upward airflow, forming a pressure difference from an outside to an inside where the outer swirling airflow has a low temperature and high pressure, and the inner swirling upward airflow has a high temperature and low pressure.

10. The dust generation simulation method of the precise concentration generating device for dust particles according to claim 8, wherein after a dust generation airflow simulation is completed, turning off the crushing motor and the high-temperature heating tube, opening the slag discharge gate, and starting the high-pressure pump, so that the water in the water tank passes through the first branch pipeline, then is uniformly sprayed into the cyclone chamber through a plurality of nozzles to form a high-pressure mist field, to wash the inner wall of the cyclone cylinder to clean the attached particle residue under the action of the high-speed outer swirling airflow in the cyclone chamber, cleaning 2-3 times in total, and each time for no less than 3 minutes; after cleaning is completed, turning off the high-pressure pump; the material conveying fan continues to blow air for at least 10 minutes, and the airflow enters the cyclone chamber through the material conveying pipeline to dry the inner wall of the cyclone cylinder; after the drying is completed, turning off the material conveying fan and closing the slag discharge gate.
